(19) United States
(12) Patent Application Publication
(10) Pub. No.: US 2023/0154315 A1
(43) Pub. Date: May 18, 2023

(54) DRIVING ASSISTANCE SYSTEM FOR A ROAD AND ASSOCIATED METHOD

(71) Applicant: ALSTOM Holdings, ST OUEN SUR SEINE (FR)

(72) Inventors: Pascal Poisson, Sceaux (FR); Pierre Cotelle, Lyon (FR)

(21) Appl. No.: 18/055,240

(22) Filed: Nov. 14, 2022

(30) Foreign Application Priority Data
Nov. 17, 2021 (FR) 21 12134

(51) Int. Cl. G08G 1/01

(52) U.S. Cl. CPC G08G 1/0141; G08G 1/0116; G08G 1/0133

(57) ABSTRACT

A driving assistance system for a road includes a number of communication units along the road. Each communication unit is able to transmit traffic data to vehicles on the road in a respective communication area. The communication units are arranged along the road so that the set of communication units presents a continuous coverage of the entire road. The traffic data of each communication unit is specific to that communication unit. The traffic data includes or is at least partially derived from traffic information detected on the road. There is an associated assistance method.

### CROSS-REFERENCE TO RELATED APPLICATION

This application claims priority to French Patent Application No. 21 12134 filed on Nov. 17, 2021, the disclosure of which including the specification, the drawings, and the claims is hereby incorporated by reference in its entirety.

### FIELD OF THE INVENTION

The present invention relates to a driving assistance system for a road, comprising a plurality of communication units along the road, each communication unit being able to transmit traffic data to vehicles on the road in a respective communication area.

The present invention further relates to an associated assistance method.

### BACKGROUND OF THE INVENTION

US 6 411 889 B1 describes a system comprising a plurality of lane terminals.

Each terminal presents a reduced range, such that it communicates with only a few vehicles. Thus, each terminal is capable of communicating with the closest vehicle or vehicles.

However, such a system is not able to provide driving assistance for a road because each terminal only communicates with a very small number of vehicles, the range not being sufficient.

### SUMMARY OF THE INVENTION

An object of the invention is therefore to propose a driving assistance system for a road.

To this end, the invention has as object a system of the aforementioned type, wherein the communication units are arranged along the road so that the set of communication units presents a continuous coverage comprising the entire road, the traffic data of each communication unit being specific to said communication unit, the traffic data comprising and/or being at least partially derived from detected road traffic information.

The continuous coverage of all the communication units thus provides communication with all the vehicles on the road and thus provides driving assistance on the entire road.

The system may furthermore have one or more of the following features, considered individually or in any technically possible combination:
the communication units are placed along the road at regular intervals;
the system is able to customize the data transmitted by the communication units, in particular as a function of an available bandwidth of the driving assistance system,
each communication unit is able to transmit the data with a period corresponding to a given unique time interval, the given unique time interval being common to the communication units, each communication unit being able to transmit the data with a time offset relative to each of the adjacent communication units
each communication unit is able to transmit to a vehicle in the communication area of said communication unit traffic data relating to said communication area,
the traffic data transmitted by each communication unit comprises the position, speed and acceleration of all vehicles in the communication area of said communication unit and the respective communication area of at least one adjacent communication unit, more particularly adjacent communication units, of said communication unit
each communication unit is able to transmit to a vehicle in the communication area of said communication unit, traffic data relating to a horizon area, the horizon area comprising, herein consisting of, the communication area of said communication unit and the communication area of the previous communication unit of said communication unit relative to a traffic direction and/or the communication areas of the at least six subsequent communication units of said communication unit relative to the traffic direction
each communication unit is adjusted so that the traffic data transmitted to a vehicle in the communication area of said communication unit comprises general information about the communication areas of the horizon area outside the communication units adjacent to said communication unit
the system comprises detection units for detecting traffic information on the road, the driving assistance system being adjusted so that each communication unit receives respective data, the respective data being and/or being derived from the traffic information detected by the detection units, and/or
the communication units are able to communicate with a vehicle via a wireless, V2X-type connection.

The invention further relates to a method of driving assistance on a road, comprising the provision of a driving assistance system of the aforementioned type, wherein each communication unit presents a range, each location on the road being within the range of at least one communication unit, each communication unit transmitting traffic data to any compatible vehicle within its range.

### BRIEF DESCRIPTION OF THE DRAWINGS

Further features and advantages of the invention will become apparent from the following description of embodiments of the invention, given by way of example only and with reference to the drawings in which:

FIG. 1 is a schematic top view of a road equipped with a system according to one embodiment of the invention, and

FIG. 2 is a schematic representation of an example of a system according to one embodiment of the invention.

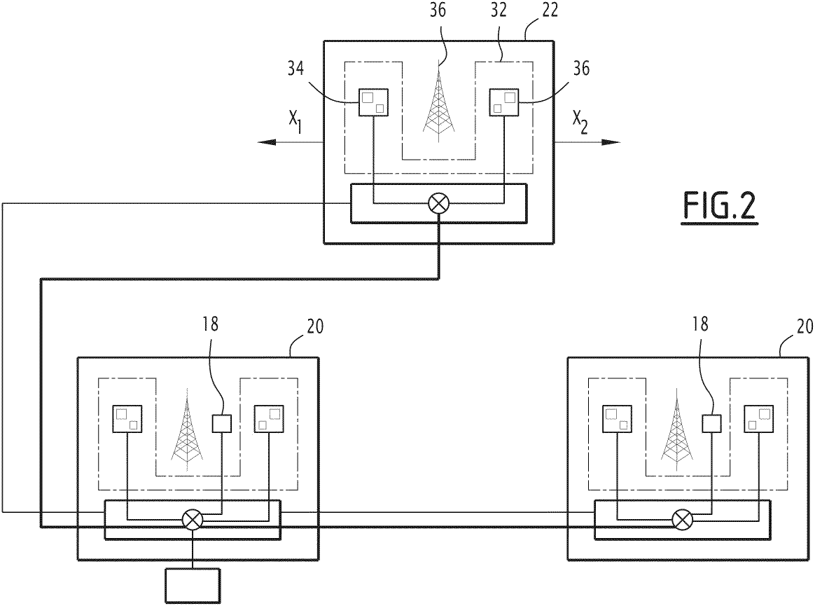

### DETAILED DESCRIPTION OF THE PREFERRED EMBODIMENTS

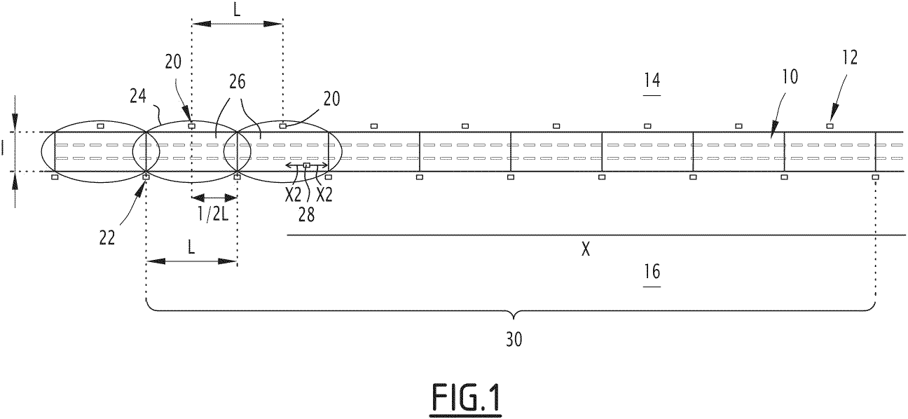

A portion of the road 10 equipped with a driving assistance system 12 according to one embodiment of the invention is schematically shown in FIG. 1. Said FIG. 1 shows only a portion of the road, and thus the system, which repeats along the road 10.

The road 10 extends in a direction X, the direction presenting two directions X1, X2.

The two directions X1, X2 correspond to the two directions of traffic in the case of a two-way road or the direction of traffic and the opposite direction in the case of a one-way road.

The unit(s) adjacent to a given unit are defined as the unit(s) flanking the given unit according to the direction of the road X.

The terms previous or next are further defined as the adjacent unit before or after the given unit according to a direction X1 or X2 of traffic. The selected direction corresponds, for example, to the direction of travel of the vehicle in question.

The road 10 defines a first side 14 and a second side 16.

The driving assistance system 12 comprises a plurality of communication units 18 along the road, more particularly on one side of the road, here on the first side 14 of the road.

The communication units 18 are able to transmit traffic data to vehicles on the road 10.

The communication units 18 are placed along the road 10 according to the direction of the road X at a regular given interval L within a margin of error, for example 5%.

The overlap is chosen to ensure coverage of adjacent areas for a given minimum time.

The regular given interval L is, for example, between 250 m and 400 m.

Specifically, in the represented example, the road 10 is provided with a plurality of roadside units 20, 22 arranged along the road 10. Some of the roadside units 20 comprise a communication unit 18.

In the represented example, some roadside units 22 are devoid of a communication unit 18.

Specifically, one in two roadside unit comprises or does not comprise a communication unit 18, alternately along the road direction X.

The roadside units 20, 22 are specifically roadside radio units.

The roadside units 20, 22 are alternately placed on the first side 14 and the second side 16 of the road 10.

Thus, each roadside unit 20, 22, apart from a possible first and/or last roadside unit, presents two adjacent units that are located on the opposite side of the road 10 relative to said roadside unit.

The roadside units 20 comprising a communication unit 18 are arranged on a same side 14 of the road and the roadside units 22 without a communication unit are arranged on the other side 16 of the road.

The roadside units 20 are placed along the road 10 according to the road direction X at an interval equal to half of the given regular interval L, within a margin of error, for example 5%.

The roadside units 20, 22 are connected to each other, for example, by a local network.

Each communication unit 18 has a given range 24.

The communication units 18 are placed along the road 10 such that the set of communication units 18 presents continuous coverage over the entire road 10, in other words, the road 10 is included in the merging of the ranges 24 of each communication unit 14.

More particularly here, the range 24 of a communication unit 18 comprises the section 26 of the road of the given regular interval L length centered on the communication unit 14 according to the direction of the road X, within the preceding margin of error.

Each communication unit 18 is able to transmit traffic data to vehicles at least along the section 26, here over the entire range 24.

In the example shown, the respective ranges 24 of two adjacent communication units 18 present a non-empty intersection. A vehicle located at the intersection is susceptible to receive data from each of the two communication units 18.

Each communication unit 18 is able to transmit the data with a period corresponding to a given unique time interval.

The given unique time interval is, for example, common to the communication units.

Each communication unit 18 is able to transmit the data with a time offset relative to each of the adjacent communication units.

In particular, this allows that, for a vehicle located at the intersection of two communication units, the communication units do not transmit traffic data to the vehicle at the same time.

The unique time interval is consistent relative to the message sending cycle.

For example, the time offset is greater than or equal to 50 ms, for a given message size and radio technology.

Each communication unit 18 is able to communicate with a vehicle or vehicles via a wireless connection, for example via Wi-Fi or cellular network.

The communication is, for example, realized by V2X technology, namely by a vehicle-to-everything communication system.

The communication is, for example, realized by the ITS-G5 standard and/or by the C-V2X standard.

The communication by ITS-G5 standard is realized by Wi-Fi (802.11p and its evolution).

The communication by C-V2X standard is realized by the 3GPP type network on the PC5 interface.

The data are, for example, transmitted by V2X messages such as CAM (Cooperative Awareness Messages) or DENM (Decentralized Environmental Notification Message).

The vehicle(s) on the road are, for example, able to receive the data via an intrinsic connectivity of the vehicle or via an additional box onboard the vehicle.

The driving assistance system is able to customize the transmitted data, in particular according to an available bandwidth of the assistance system.

More particularly, the driving assistance system is able to personalize the data transmitted by each communication unit 18 independently, in particular as a function of an available bandwidth of the communication unit 18.

In particular, the adaptation makes it possible to manage a large number of vehicles, for example in the case of traffic at the limit of saturation, namely, with many vehicles moving relatively quickly.

The data transmitted to a vehicle 28 by a communication unit 18 comprises, more particularly corresponds to, information relating to a horizon area 30 of the road.

The horizon area 30 of a communication unit 18 here comprises a communication area of said communication unit 18, a communication area of the previous communication unit and/or communication areas of a plurality of subsequent communication units.

The number of subsequent communication units in the horizon area is, for example, selected to cover the desired horizon area.

In the example described, the communication area of a communication unit 18 corresponds to the section 26.

The horizon area 30 comprises, here corresponds to, the section 26 of the road included in the range 24 of the given communication unit 18, the preceding section and a plurality of subsequent sections, here more particularly the next six or seven sections.

The traffic data transmitted by a communication unit 18 comprises the position, speed and acceleration of all vehicles in the communication area of said communication unit 18 and the communication areas of the adjacent communication units of said communication unit 18, namely, the previous communication unit and the next communication unit.

The traffic data transmitted by a communication unit 18 further comprises general information about the rest of the horizon area 30, outside the communication area of said communication unit and adjacent communication units. The general information comprises, for example, average speed of vehicles, minimum and maximum speed of vehicles included in subsets of the rest of the horizon area for each subset. The subsets are, for example, a portion of each lane, in this case the sections of each lane corresponding to each of the sections 26 of the road.

Thus, accurate data about all vehicles near the vehicle communicating with the communication unit is provided by the communication unit to the vehicle, but only general indications about the more distant areas. This makes it possible to provide useful information to anticipate an event such as a major slowdown, without overloading a vehicle or a user with information that is too far away and without saturating the bandwidth.

In one embodiment, the traffic data transmitted by a communication unit 18 comprises, for example, in addition, the position and size of possible obstacles present on the road at least in the horizon area 30.

In one embodiment, the traffic data transmitted by a communication unit 18 comprises, for example, furthermore, dynamic signaling information present on the road at least in the horizon area 30, for example a possible speed limit, a possible lane closure, a possible specific trajectory to be observed, etc.

In the example shown, each roadside unit 20, 22 comprises a detection unit 32 for traffic information on the road 10.

Each detection unit 32 comprises, for example, a first subassembly 34 detecting information from the roadside unit 20, 22 in a first direction X1 of the road 10 and a second subassembly 36 detecting information from the roadside unit 20, 22 in the second direction X2 of the road.

The assistance system 12 is adjusted so that each communication unit 18 receives respective data, the respective data being and/or being derived from the traffic information detected by the detection units 32.

The data transmitted by each communication unit is at least partially derived from the received data.

A virtual scene is, for example, reconstructed from the traffic information detected by the detection units 32.

This makes it possible, for example, to compensate for a possible occultation of one or more detection units and/or an error at a location, by viewing the traffic virtually.

Alternatively, the detection units 32 are arranged separately from the roadside units 20 comprising the communication units 18.

Alternatively, the data transmitted by the communication units 18 is not obtained by the road traffic information detection units arranged in the roadside units 20, 22. The data is, for example, provided by a general control center.

Each roadside unit 20, 22 here further comprises an antenna 36 for communication with, for example, a central system (not shown).

An example of a method for driving assistance on a road will now be described relative to the previously described system.

The method comprises providing an assistance system as described above.

Each communication unit presents a range, each location on the road being included within the range of at least one communication unit, as previously highlighted.

Each communication unit transmits traffic data to any compatible vehicle within its range.

The transmission occurs with a period corresponding to the given unique time interval.

Advantageously, each communication unit transmits the data with a time offset, relative to each of the adjacent communication units.

The transmitted traffic data is, for example, adjusted as described above.

The vehicle(s) on the road are, for example, able to receive the data via intrinsic vehicle connectivity or via an additional box onboard the vehicle.

The data transmitted by each communication unit is derived, at least partially, from received data.

The received data is, or is derived from, traffic information detected by the detection units 32 in one of the variants described above.

Additionally, or alternatively, each communication unit is able to receive additional data, for example from a general control center.

A driving assistance system according to the invention covers the entire road and is therefore able to transmit information to all vehicles present on the road.

In particular, this allows a driver to know data that may be useful for driving and/or to provide useful information to a vehicle in a driving delegation mode.

What is claimed is:

1. A driving assistance system for a road, comprising a plurality of communication units along the road, each communication unit being able to transmit traffic data to vehicles on the road in a respective communication area, wherein the communication units are arranged along the road so that the set of communication units presents a continuous coverage comprising the whole road, the traffic data of each communication unit being specific to said communication unit, the traffic data comprising and/or being at least partially derived from traffic information detected on the road, each communication unit being able to transmit to a vehicle in the communication area of said communication unit traffic data relating to a horizon area, the horizon area comprising the communication area of said communication unit and the communication area of the previous communication unit of said communication unit relative to a direction of travel and/or the communication areas of the at least six subsequent communication units of said communication unit relative to the direction of travel, each communication unit being adapted such that the traffic data transmitted to a vehicle in the communication area of said communication unit comprises general information about the communication areas of the horizon area outside the communication units adjacent to said communication unit.

2. The driving assistance system according to claim 1, wherein the communication units are placed along the road at regular intervals.

3. The driving assistance system according to claim 1, able to customize the data transmitted by the communication units.

4. The driving assistance system according to claim 3, wherein the data transmitted by the communication units are customized as a function of an available bandwidth of the driving assistance system.

5. The driving assistance system according to claim 1, wherein each communication unit is able to transmit the data with a period corresponding to a given unique time interval, the given unique time interval being common to the communication units, each communication unit being able to transmit the data with a time offset relative to each of the adjacent communication units.

6. The driving assistance system according to claim 1, wherein the traffic data transmitted by each communication unit comprises the position, speed and acceleration of all vehicles in the communication area of said communication unit and the respective communication area of at least one adjacent communication unit of said communication unit.

7. The driving assistance system according to claim 6, wherein the traffic data transmitted by each communication unit comprises the position, speed and acceleration of all vehicles in the communication area of said communication unit and the respective communication area of adjacent communication units of said communication unit.

8. The driving assistance system according to claim 1, wherein the horizon area consists of the communication area of said communication unit and the communication area of the previous communication unit of said communication unit relative to a traffic direction and/or the communication areas of the at least six subsequent communication units of said communication unit relative to the traffic direction.

9. The driving assistance system according to claim 1, comprising detection units for detecting traffic information on the road, the driving assistance system being adapted such that each communication unit receives respective data, the respective data being and/or being derived from the traffic information detected by the detection units.

10. The driving assistance system according to claim 1, wherein the communication units are able to communicate with a vehicle via a wireless, V2X-type connection.

11. A driving assistance method on a road, comprising the provision of a driving assistance system according to claim 1, wherein each communication unit presents a range, each location on the road being within the range of at least one communication unit, each communication unit transmitting traffic data relative to a horizon area to any compatible vehicle within its range, the horizon area comprising the communication area of said communication unit and the communication area of the previous communication unit of said communication unit relative to a direction of travel and/or the communication areas of the at least six subsequent communication units of said communication unit relative to the direction of travel, the traffic data transmitted by the communication unit comprising general information about the communication areas of the horizon area outside of the communication units adjacent to said communication unit.
